(19) United States
(12) Patent Application Publication
(10) Pub. No.: US 2014/0110031 A1
(43) Pub. Date: Apr. 24, 2014

(54) RUBBER COMPOSITION FOR INNER-LINER JOINT STRIP, AND PNEUMATIC TIRE

(71) Applicant: SUMITOMO RUBBER INDUSTRIES, LTD., Kobe-shi (JP)

(72) Inventor: Tatsuya MIYAZAKI, Kobe-shi (JP)

(73) Assignee: SUMITOMO RUBBER INDUSTRIES, LTD., Kobe-shi (JP)

(21) Appl. No.: 14/059,021

(22) Filed: Oct. 21, 2013

(30) Foreign Application Priority Data
Oct. 22, 2012 (JP) 2012-233219

(51) Int. Cl. B60C 1/00

(52) U.S. Cl. CPC B60C 1/0008
USPC 152/510; 524/574

(57) ABSTRACT

A rubber composition for an inner-liner joint strip is capable of improving green strength and adhesion, while maintaining good durability (oxidative degradation resistance, crack growth resistance) and good air retention properties, which are exhibited by a pneumatic tire formed from the composition. The rubber composition for an inner-liner joint strip, includes: a butyl rubber; silica and/or carbon black; and an alkylphenol-sulfur chloride condensate represented by formula (1) below, wherein a butyl rubber content is 60 to 100 mass % based on 100 mass % of the rubber component of the rubber composition, a total combined amount of the silica and the carbon black is 21 to 70 parts by mass per 100 parts by mass of the rubber component, and an amount of the alkylphenol-sulfur chloride condensate is 0.1 to 5 parts by mass per 100 parts by mass of the rubber component.

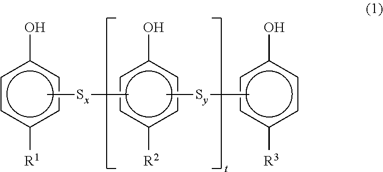

### TECHNICAL FIELD

The present invention relates to a rubber composition for an inner-liner joint strip and a pneumatic tire formed from the composition.

### BACKGROUND ART

An inner liner is provided on the inner surface of a tire in order to prevent air charged in the interior of the tire from permeating outside the tire, thereby preventing a reduction in internal pressure. The inner liner is formed by mutually jointing both edges of a rubber sheet on a tire building drum, assembling it with other components in the building machine, and then vulcanizing the assembly. Separation of the joint of the inner liner (breakage of the joint) may occur by application of shaping pressure during building or by application of pressure from a bladder during vulcanization. If separation of the joint occurs, then undesirable rubber flow is caused during vulcanization, which leads to insertion of foreign matter, and also a larger strain is applied to such a portion than its surroundings during driving, which is likely to cause cracks. In order to overcome these problems, i.e., to prevent separation of the joint and insertion of foreign matter, the joint of the inner liner is covered by an inner-liner joint strip.

Now, referring to the drawings, the inner-liner joint strip will be described below. FIG. 1 is a schematic sectional view showing the proximity of the bead portion of a tire. In FIG. 1, an inner-liner joint strip 1, an inner liner 2, a tie gum 3, a filler 4 and a carcass ply 5 are arranged in this order from the interior. A rubber chafer 6 is provided at locations where the inner liner 2, tie gum 3 and carcass ply 5 are adjacent to a rim.

FIG. 2 is a schematic view showing an assembly of an inner liner and a tie gum joined together before subjecting to assembling and building. As shown in FIG. 2, the width of the inner liner 2 is generally shorter than the width of the tie gum 3.

FIG. 3 is a schematic view showing a tire building drum on which an inner liner, an inner-liner joint strip, a tie gum and a bead wire are assembled. In FIG. 3, the region indicated by A is the joint of the inner liner.

FIG. 4 is a schematic view showing a tire shaped by a building machine to assemble a breaker and a tread package with a carcass material. Here, as shown in FIG. 4, three steel breakers 8 and a carcass ply 5 are arranged underlying a tread 7.

FIG. 5 is a schematic view showing the joint of an inner liner in a vulcanized tire. In FIG. 5, the region indicated by reference symbol a is a portion in which separation of the joint occurs due to peel-off or folding of the inner-liner joint strip, whereas the region indicated by reference symbol b is a portion in which the inner-liner joint strip is smoothly stretched and thus has good conditions. A schematic sectional view of the region indicated by a is shown in FIG. 6 and a schematic sectional view of the region indicated by b is shown in FIG. 7.

The inner-liner joint strip is required to have functions such as green strength (rubber strength before vulcanization), adhesion, elongation at break, oxidative degradation resistance, crack growth resistance and air retention properties. Of them, green strength, adhesion before vulcanization and oxidative degradation resistance are important.

As a method for ensuring air retention properties, a method of using a butyl rubber such as halogenated butyl rubber is known (for example, see Patent Literature 1). However, sufficient studies have not been conducted to improve important properties of the inner-liner joint strip, such as green strength.

### CITATION LIST

### Patent Literature

Patent Literature 1: JP 2009-132368 A

### SUMMARY OF INVENTION

### Technical Problem

An object of the present invention is to solve the aforementioned problems and provide a rubber composition for an inner-liner joint strip, capable of improving important properties of the inner-liner joint strip, i.e., green strength and adhesion, while maintaining good durability (oxidative degradation resistance, crack growth resistance) and good air retention properties, and a pneumatic tire formed from the rubber composition.

### Solution to Problem

The present invention relates to a rubber composition for an inner-liner joint strip, including a butyl rubber, at least one of silica and carbon black, and an alkylphenol-sulfur chloride condensate represented by the following formula (1):

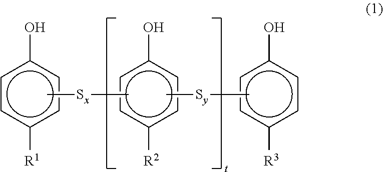

wherein R¹, R² and R³, which may be the same or different, each represent an alkyl group having 5 to 12 carbon atoms; x and y, which may be the same or different, each represent an integer of 1 to 3; and t represents an integer of 0 to 250,

wherein a butyl rubber content is 60 to 100 mass % based on 100 mass % of a rubber component of the rubber composition, a total combined amount of the silica and the carbon black is 21 to 70 parts by mass per 100 parts by mass of the rubber component, and an amount of the alkylphenol-sulfur chloride condensate is 0.1 to 5 parts by mass per 100 parts by mass of the rubber component.

Preferably, a sulfur content is 0 to 0.4 parts by mass per 100 parts by mass of the rubber component.

The present invention also relates to a pneumatic tire, including an inner-liner joint strip formed from the aforementioned rubber composition, and an inner liner, wherein an initial curing rate t10 of the inner-liner joint strip and an initial curing rate t10 of the inner liner satisfy the following relationship:

0.5≦(initial curing rate t10 of inner-liner joint strip)/(initial curing rate t10 of inner liner)≦2.

Preferably, the pneumatic tire is a tire with steel belts and a steel carcass.

### Advantageous Effects of Invention

According to the present invention, the rubber composition for an inner-liner joint strip contains: a butyl rubber; silica and/or carbon black; and a specific alkylphenol-sulfur chloride condensate, each in a predetermined amount. Thus, when the rubber composition is used for an inner liner joint, a joint of an inner liner can be formed and vulcanized without problems and therefore a pneumatic tire excellent in durability (oxidative degradation resistance, crack growth resistance) and air retention properties can be provided.

### BRIEF DESCRIPTION OF DRAWINGS

FIG. 1 is a schematic sectional view showing the proximity of the bead portion of a tire.

FIG. 2 is a schematic view showing an assembly of an inner liner and a tie gum joined together before subjecting to assembling and building.

FIG. 3 is a schematic view showing a tire building drum on which an inner liner, an inner-liner joint strip, a tie gum and a bead wire are assembled.

FIG. 4 is a schematic view showing a tire shaped by a building machine to unite a breaker, a tread package and a carcass material.

FIG. 5 is a schematic view showing the joint of an inner liner in a vulcanized tire.

FIG. 6 is a schematic sectional view of the region indicated by reference symbol a shown in FIG. 5.

FIG. 7 is a schematic sectional view of the region indicated by reference symbol b shown in FIG. 5.

FIG. 8 is a schematic sectional view of the normal joint of an inner liner (before vulcanization).

FIG. 9 is a schematic sectional view of the joint of an inner liner, dislocated from its normal position (before vulcanization).

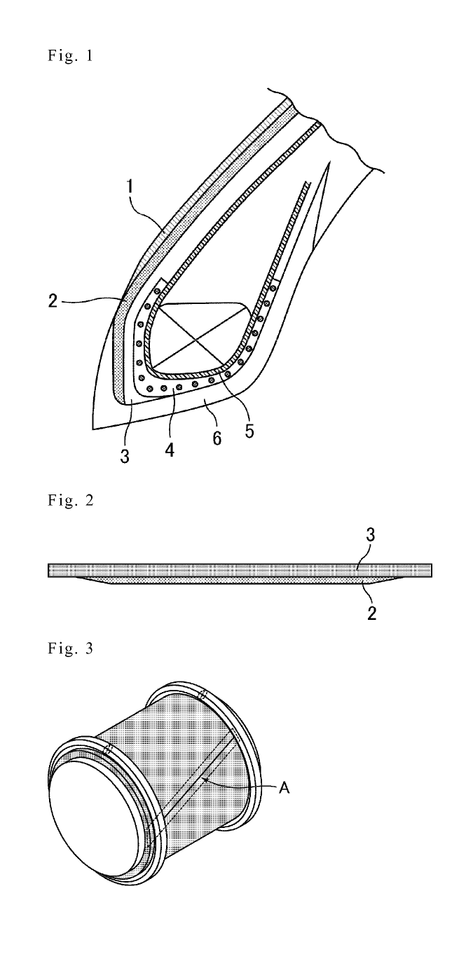

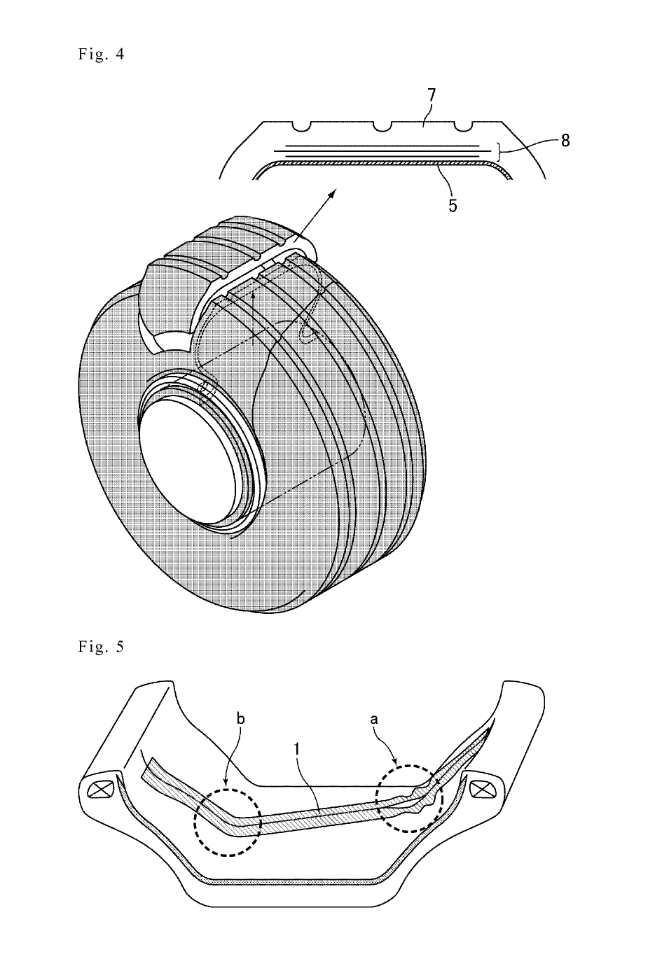

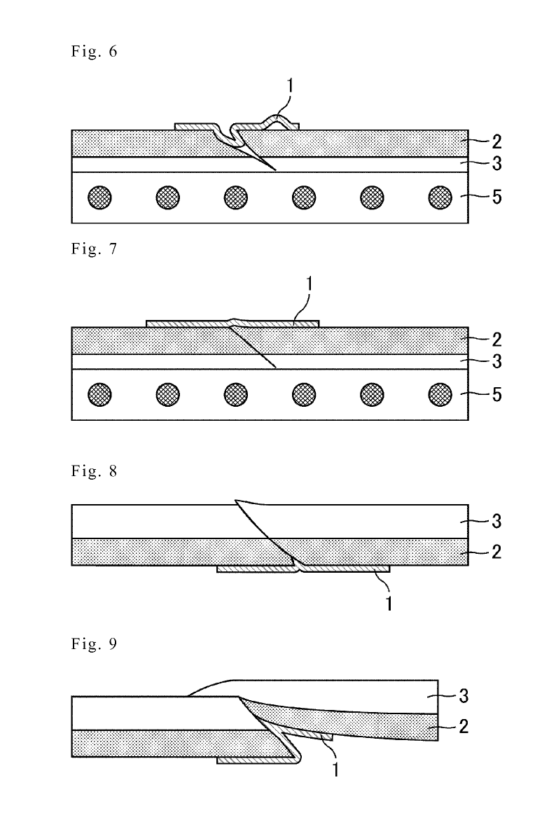

### DESCRIPTION OF EMBODIMENTS

The rubber composition for an inner-liner joint strip of the present invention contains: a butyl rubber; silica and/or carbon black; and a specific alkylphenol-sulfur chloride condensate, each in a predetermined amount.

Co-curing can be achieved between an inner-liner joint strip and an inner liner or tie gum when the inner-liner joint strip is formed by adding a predetermined amount of the alkylphenol-sulfur chloride condensate to a rubber composition in which the butyl rubber content and the amount of silica and carbon black are appropriately adjusted. In this case, good green strength and adhesion can also be achieved. Owing to these effects, a joint of an inner liner can be formed and vulcanized without problems and separation of the joint can be suppressed. In addition, good levels of oxidative degradation resistance, crack growth resistance and air retention properties, which are important properties during use, can be ensured.

Examples of the butyl rubber include halogenated butyl rubbers (X-IIR) such as brominated butyl rubber (Br-IIR) and chlorinated butyl rubber (Cl-IIR) and non-halogenated butyl rubber (IIR). In addition, the butyl rubber may be a reclaimed butyl rubber prepared from a rubber product such as a bladder containing a large amount of a butyl rubber. Of them, halogenated butyl rubbers are preferred and brominated butyl rubber is more preferred, since they have good crosslinking reactivity and air retention properties.

The butyl rubber content, based on 100 mass % of the rubber component of the rubber composition, is 60 mass % or more, preferably 65 mass % or more, and more preferably 70 mass % or more. If the butyl rubber content is less than 60 mass %, sufficient air retention properties may not be ensured. The butyl rubber content may be 100 mass %, and is preferably 95 mass % or less, and more preferably 90 mass % or less, since then good green strength and good adhesion before vulcanization are obtained.

Examples of other rubber materials that can be used as the rubber component include, but not limited to, natural rubber (NR), isoprene rubber (IR), styrene-butadiene rubber (SBR), butadiene rubber (BR), epoxidized natural rubber (ENR) and styrene-isoprene-butadiene copolymer rubber (SIBR). Of them, NR and IR are preferred since they provide good green strength and good adhesion before vulcanization.

Although the NR is not particularly limited, NR generally used in the tire industry, such as SIR20, RSS#3 and TSR20, can be used. Similarly, the IR may be one generally used in the tire industry, such as IR2200.

The NR content, based on 100 mass % of the rubber component, is preferably 5 mass % or more, and more preferably 10 mass % or more. If the NR content is less than 5 mass %, then green strength and adhesion before vulcanization may not be sufficiently improved. The NR content is preferably 40 mass % or less, and more preferably 35 mass % or less. If the NR content exceeds 40 massa, the butyl rubber content is relatively reduced, so that air retention properties, oxidative degradation resistance and crack growth resistance may not be sufficiently ensured. In addition, the curing rate tends to increase.

The rubber composition of the present invention contains carbon black and/or silica as a reinforcing material. Carbon black is preferably used as a reinforcing material since it provides good green strength, elongation at break, and crack growth resistance.

The nitrogen adsorption specific surface area (N₂SA) of carbon black is preferably 15 m²/g or more, more preferably 25 m²/g or more, and further preferably 30 m²/g or more. If N₂SA is less than 15 m²/g, sufficient reinforcement may not be obtained. The N₂SA of carbon black is preferably 60 m²/g or less, more preferably 50 m²/g or less, and further preferably 45 m²/g or less. If N₂SA exceeds 60 m²/g, the rubber composition may become so hard that elongation at break may be reduced.

It should be noted that the nitrogen adsorption specific surface area of carbon black is a value measured in accordance with JIS K 6217-2: 2001.

The nitrogen adsorption specific surface area (N₂SA) of silica is preferably 50 m²/g or more, and more preferably 70 m²/g or more. If N₂SA is less than 50 m²/g, sufficient reinforcement may not be obtained. The N₂SA of silica is preferably 220 m²/g or less, and more preferably 200 m²/g or less. If N₂SA exceeds 220 m²/g, air retention properties and elongation at break may be reduced.

It should be noted that the N₂SA of silica is a value measured by the BET method in accordance with ASTM D3037-81.

The total combined amount of carbon black and silica, per 100 parts by mass of the rubber component, is 21 to 70 parts by mass since good green strength and sheet processability can then be obtained. The lower limit of the total combined amount of carbon black and silica is preferably 35 parts by mass or more, and more preferably 45 parts by mass or more, whereas the upper limit is preferably 60 parts by mass or less, and more preferably 55 parts by mass or less.

For the same reason, the amount of carbon black per 100 parts by mass of the rubber component is preferably 21 part by mass or more, more preferably 35 parts by mass or more, and further preferably 45 parts by mass or more, and is preferably 70 parts by mass or less, more preferably 60 parts by mass or less, and further preferably 55 parts by mass or less. Furthermore, the amount of silica per 100 parts by mass of the rubber component is preferably 0 to 30 parts by mass. If silica is added, then elongation at break is improved; however, the addition of silica may lead to shrinkage of the rubber composition following cooling after extrusion, as well as detachment of a strip edge during shaping.

The rubber composition of the present invention may contain another filler as an extender other than silica and carbon black. As other fillers, bituminous coal and hard clay can be suitably used. When the rubber composition of the present invention contains bituminous coal, the amount of bituminous coal per 100 parts by mass of the rubber component is preferably 5 parts by mass or more, and more preferably 15 parts by mass or more, and is preferably 30 parts by mass or less, and more preferably 25 parts by mass or less. Moreover, when the rubber composition of the present invention contains hard clay, the amount of hard clay per 100 parts by mass of the rubber component is preferably 5 parts by mass or more, and more preferably 10 parts by mass or more, and is preferably 30 parts by mass or less, and more preferably 25 parts by mass or less.

The rubber composition of the present invention contains an alkylphenol-sulfur chloride condensate represented by the following formula (1). Thus, the alkylphenol-sulfur chloride condensate in an inner-liner joint strip can migrate to an inner liner and consequently co-curing can be achieved between the inner-liner joint strip and the inner liner or tie gum.

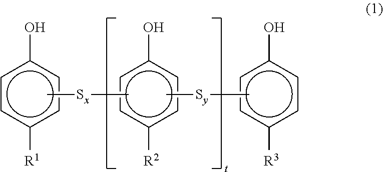

In the formula, R¹, R² and R³, which may be the same or different, each represent an alkyl group having 5 to 12 carbon atoms; x and y, which may be the same or different, each represent an integer of 1 to 3; and t represents an integer of 0 to 250.

FIG. 8 is a schematic sectional view of the normal joint of an inner liner and FIG. 9 is a schematic sectional view of the joint of an inner liner, dislocated from its normal position. In FIGS. 8 and 9, the upper side is where other components such as a carcass ply are attached, whereas the lower side faces a tire building drum. An inner-liner joint strip 1, an inner liner 2 and a tie gum 3 are arranged in this order from the side facing the tire building drum. As shown in FIG. 8, the inner-liner joint strip is normally in contact with the inner liner but not in contact with the tie gum. However, as shown in FIG. 9, if the joint is dislocated from its normal position, the inner-liner joint strip may come into contact with both the inner liner and the tie gum. For this reason, the inner-liner joint strip needs to show vulcanization adhesion and green strength strong enough to co-cure not only with the inner liner but also with the tie gum. The alkylphenol-sulfur chloride condensate represented by formula (1) is preferred because it has high compatibility with both the butyl rubber and NR, and thus the inner liner joint strip containing the alkylphenol-sulfur chloride condensate can be vulcanization bonded to both the inner liner and the tie gum.

The symbol t is an integer of 0 to 250, preferably an integer of 0 to 100, further preferably an integer of 10 to 100, and particularly preferably an integer of 20 to 50, because the alkylphenol-sulfur chloride condensate disperses well into the rubber component. The symbols x and y are preferably both 2 because then high hardness is efficiently obtained. R¹ to R³ are each preferably an alkyl group having 6 to 9 carbon atoms because the alkylphenol-sulfur chloride condensate disperses well into the rubber component.

The alkylphenol-sulfur chloride condensate can be prepared by a method known in the art. For example, mention may be made of a method of reacting an alkylphenol and sulfur chloride in a molar ratio of e.g., 1:0.9 to 1.25. Specific examples of the alkylphenol-sulfur chloride condensate include Tackirol V200 (in formula (1), R¹, R², R³: octyl group (—C₈H₁₇); x, y: 2; t: 0 to 100), and TS3101 (in formula (1), R¹, R², R³: dodecyl group (—C₁₂H₂₅); x, y: 2; t: 150 to 200) manufactured by Taoka Chemical Co., Ltd.

The amount of the alkylphenol-sulfur chloride condensate per 100 parts by mass of the rubber component is 0.1 parts by mass or more, preferably 0.5 parts by mass or more, and more preferably 0.8 parts by mass or more. If the amount is less than 0.1 parts by mass, the addition of the alkylphenol-sulfur chloride condensate may not sufficiently produce its effects and the finished (joint) state of the joint of the inner liner may be deteriorated. The amount of the alkylphenol-sulfur chloride condensate is 5 parts by mass or less, preferably 4 parts by mass or less, and further preferably 3 parts by mass or less. If the amount exceeds 5 parts by mass, the curing rate is likely to be so high that compound scorch may occur and elongation at break tends to be reduced.

If the curing rate of an inner-liner joint strip greatly differs from that of an inner liner, the inner-liner joint strip may peel off so that problems can occur such that the joint of the inner liner is not be covered. For this reason, the inner-liner joint strip needs to be vulcanized synchronously with the inner liner. However, if a large amount of sulfur is added into the rubber composition of the present invention, the curing rate of the inner-liner joint strip may become so high that the inner-liner joint strip cannot be vulcanized synchronously with the inner liner. Moreover, it is possible to control the curing rate by adding a retarder suitable for a butyl rubber, such as magnesium oxide, together with sulfur; however, the addition of the retarder may reduce elongation at break. Hence, in the rubber composition of the present invention, the sulfur content is preferably as low as possible. In view of this, the sulfur content per 100 parts by mass of the rubber component is preferably 0.4 parts by mass or less, more preferably 0.2 parts by mass or less, further preferably 0.099 parts by mass or less, and particularly preferably 0 parts by mass (substantially not contained).

The rubber composition of the present invention preferably contains a tackifying resin. Examples of usable tackifying resins include non-reactive phenolic resins and mixtures of aromatic hydrocarbon resins and aliphatic hydrocarbon resins. Non-reactive phenolic resins are preferred because they provide good adhesion before vulcanization.

The non-reactive phenolic resin is not particularly limited and may be one generally used in the tire industry. Non-reactive alkylphenol resins are preferred and non-reactive para-alkylphenol resins are more preferred, because butyl rubbers are highly soluble in these resins and strong adhesion can then be obtained. The non-reactive alkylphenol resin refers to an alkylphenol resin which is less likely to cause a condensation reaction since it has a functional group at the ortho or para position to the hydroxy group of a benzene ring in the chain. For example, compounds represented by the following formula (2) or (3) may be mentioned. Also, the non-reactive para-alkylphenol resin refers to an alkylphenol resin which has a single hydroxy group in a benzene ring in the chain, has no functional group at the ortho or meta position to the hydroxy group, and has an alkyl group at the para position to the hydroxy group. For example, compounds represented by the following formula (2) may be mentioned.

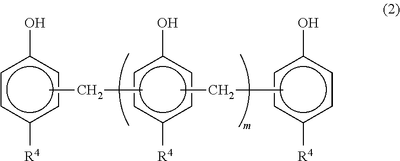

In the formula (2), the symbol m represents an integer. The symbol m is preferably 1 to 10, and more preferably 2 to 9 because appropriate bloom resistance can then be obtained. R⁴s, which may be the same or different, each represent an alkyl group whose number of carbon atoms is preferably 4 to 15, and more preferably 6 to 10 because then the affinity for the rubber component is good.

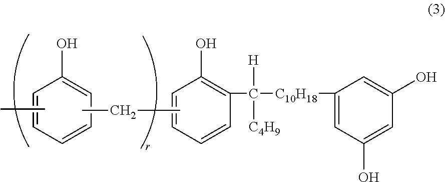

In the formula (3), the symbol r represents an integer, and r is preferably 1 to 10, and more preferably 2 to 9 because appropriate bloom resistance can then be obtained.

The amount of the tackifying resin per 100 parts by mass of the rubber component is preferably 0.5 parts by mass or more, more preferably 1.5 parts by mass or more, and further preferably 2.5 parts by mass or more. If the amount is less than 0.5 parts by mass, then adhesion before vulcanization may not be sufficiently improved. The amount of the tackifying resin is preferably 10 parts by mass or less, more preferably 6 parts by mass or less, and further preferably 4 parts by mass or less. If the amount exceeds 10 parts by mass, then adhesion before vulcanization may become so high that processability (building/assembling workability) can be deteriorated.

The rubber composition of the present invention may appropriately contain, in addition to the aforementioned components, additives generally used for the preparation of a rubber composition, for example, oil, a vulcanization accelerator, zinc oxide, stearic acid and an antioxidant. Furthermore, a retarder suitable for a butyl rubber may be added.

Examples of the oil include aromatic oil, process oil and paraffin oil. Of them, paraffin oil is preferred because it is highly effective in accelerating dispersion of filler, it has good compatibility with rubber and is thus less likely to bleed, and it improves sheet processability of a rubber composition.

The amount of oil per 100 parts by mass of the rubber component is preferably 1 part by mass or more, more preferably 3 parts by mass or more, and further preferably 5 parts by mass or more. If the amount is less than 1 part by mass, dispersibility of filler and sheet processability of a rubber composition may not be sufficiently improved. The amount of oil is preferably 15 parts by mass or less, more preferably 10 parts by mass or less, and further preferably 8 parts by mass or less. If the amount exceeds 15 parts by mass, sufficient air retention properties and green strength may not be ensured.

Examples of the vulcanization accelerator include sulfenamide, thiazole, thiuram, thiourea, guanidine, dithiocarbamate, aldehyde-amine or aldehyde-ammonia, imidazoline and xanthate vulcanization accelerators. Of them, thiazole vulcanization accelerators are preferred and di-2-benzothiazolyl disulfide is more preferred since they have high melting points and are less likely to cause compound scorch.

The amount of the vulcanization accelerator per 100 parts by mass of the rubber component is preferably 0.2 parts by mass or more, more preferably 0.5 parts by mass or more, and further preferably 0.8 parts by mass or more. If the amount is less than 0.2 parts by mass, a sufficient curing rate and crosslink density may not be ensured. The amount of the vulcanization accelerator is preferably 5 parts by mass or less, more preferably 3 parts by mass or less, and further preferably 2 parts by mass or less. If the amount exceeds 5 parts by mass, the crosslink density may become so high that elongation at break and flex crack growth resistance can be reduced.

The zinc oxide is not particularly limited and may be one generally used in the tire industry, such as zinc oxides #1 and #2.

The amount of zinc oxide per 100 parts by mass of the rubber component is preferably 1 part by mass or more, and more preferably 2 parts by mass or more. If the amount is less than 1 part by mass, a sufficient curing rate may not be ensured. In addition, its function as an acceptor for a substance such as hydrogen sulfide generated from sulfur during vulcanization, in other words, the function as an acid acceptor to protect the polymer, may be diminished and thus elongation at break after deterioration or during use may not be sufficiently ensured. The amount of zinc oxide is preferably 10 parts by mass or less, and more preferably 5 parts by mass or less. If the amount exceeds 10 parts by mass, a dispersion failure of zinc oxide may be caused.

Stearic acid reacts with zinc oxide in a rubber composition to form zinc stearate. The zinc stearate can bloom to the surface of the rolled rubber sheet to thereby reduce adhesion before vulcanization. For this reason, in the rubber composition of the present invention, the amount of stearic acid is preferably as low as possible to suppress formation of zinc stearate. In view of this, the amount of stearic acid per 100 parts by mass of the rubber component is preferably 3 parts by mass or less, more preferably 2 parts by mass or less, and further preferably 1.5 parts by mass or less. The lower limit of the amount of stearic acid is not particularly limited, and the amount is preferably 0.1 parts by mass or more, in view of ensuring a good curing rate.

The antioxidant for use in a general diene rubber may suitably be a secondary amine compound such as N-phenyl-N′-(1,3-dimethylbutyl)-p-phenylenediamine. Moreover, a primary amine compound is also contained in a quinoline antioxidant such as 2,2,4-trimethyl-1,2-dihydroquinoline polymer (TMDQ) as an unreacted monomer or a by-product. The primary or secondary amine compound can exert a synergistic effect with zinc oxide in a halogenated butyl rubber composition to cause compound scorch during processing. For this reason, the amount of the antioxidant in the rubber composition of the present invention is preferably as low as possible. In view of this, the amount of the antioxidant per 100 parts by mass of the rubber component is preferably 1.0 part by mass or less, more preferably 0.5 parts by mass or less, and further preferably 0 parts by mass (substantially not contained).

As described above, since retarders such as magnesium oxide have a drawback in dispersibility, their addition may cause a decrease in elongation at break. For this reason, the amount of the retarder in the rubber composition of the present invention is preferably as low as possible. In view of this, the amount of the retarder per 100 parts by mass of the rubber component is preferably 0.5 parts by mass or less, more preferably 0.1 parts by mass or less, and further preferably 0 parts by mass (substantially not contained).

The method for preparing the rubber composition of the present invention may be a method known in the art. For example, the rubber composition can be prepared by kneading components by a rubber kneader such as an open roll mill and a Banbury mixer, and thereafter vulcanizing the mixture.

The rubber composition of the present invention is used in an inner-liner joint strip of a tire. The inner-liner joint strip refers to a component provided so as to cover the joint of an inner liner from the inner side of a tire, in other words, from the side in contact with a vulcanization bladder.

Preferably, the pneumatic tire of the present invention includes an inner liner and an inner-liner joint strip formed from the rubber composition and the initial curing rate t10 of the inner-liner joint strip and the initial curing rate t10 of the inner liner satisfy the following relationship. In this case, the curing reactions of the inner-liner joint strip and the inner liner can be allowed to proceed synchronously to suppress problems such as peel-off of the inner-liner joint strip while reinforcing the joint of the inner liner.

0.5≦(initial curing rate t10 of inner-liner joint strip)/(initial curing rate t10 of inner liner)≦2

It should be noted that the initial curing rate t10 refers to the scorch time measured in accordance with JIS K 6300-1: 2001. More specifically, in a Mooney viscosity-time curve which is obtained by performing a Mooney scorch test using an L-rotor at 130° C., the time at which the Mooney viscosity is increased by 10 M from Vm (minimum value of Mooney viscosity) is the initial curing rate t10.

Each of the initial curing rates t10 of the inner-liner joint strip and inner liner is preferably about 11 to 20 minutes. Furthermore, each of the initial curing rates t10 of components adjacent to the inner liner, i.e., a tie gum, rubber chafer and canvas chafer, is preferably about 12 to 25 minutes.

In the case of an all-steel tire (tire (pneumatic tire) with steel belts and a steel carcass), which is a major application of the pneumatic tire of the present invention, since many of the tire components are formed from natural rubber-based compositions possibly leading to reversion, the vulcanization temperature is preferably 135 to 160° C. Moreover, although the vulcanization time varies depending on the maximum thickness of the tread portion, it is preferably 25 to 45 minutes.

In the pneumatic tire of the present invention, the rubber composition for an inner liner is not particularly limited and may be the same rubber composition as that of the present invention.

In the rubber composition for an inner liner, the butyl rubber content is preferably 60 to 100 mass %, and more preferably 80 to 100 mass %, based on 100 mass % of the rubber component of the rubber composition for an inner liner.

Moreover, the total combined amount of silica and carbon black, per 100 parts by mass of the rubber component, is preferably 21 to 70 parts by mass, and more preferably 40 to 70 parts by mass.

Furthermore, the amount of the alkylphenol-sulfur chloride condensate represented by formula (1) per 100 parts by mass of the rubber component is preferably 0.1 to 5 parts by mass, and more preferably 0.3 to 2 parts by mass.

The pneumatic tire of the present invention can be suitably used as an all-steel tire. The all-steel tire is a tire in which cords forming a carcass and a breaker are steel cords, and is suitable for heavy load tires and industrial tires (for construction machines, ore carrying vehicles and the like) which are prone to suffer problems in building and vulcanization processes, and require excellent durability. The steel cords used in the all-steel tire have substantially no expansion and stretch, whereas fiber cords made of polyester (PE), polyethylene terephthalate (PET) or the like expand and stretch. Hence, in the all-steel tire, separation of the joint of an inner liner tends to occur easily. Thus the present invention is particularly effective in the all-steel tire.

The pneumatic tire of the present invention can be produced using the aforementioned rubber composition according to an ordinary method. Specifically, the rubber composition, not yet vulcanized, is extruded and processed into the shape of an inner-liner joint strip, and then arranged in a tire building machine by an ordinary method and assembled with other components such as an inner liner to form an unvulcanized tire. The unvulcanized tire is heated and pressurized in a vulcanizer to produce a tire.

### EXAMPLES

The present invention will be more specifically described with reference to Examples; however, the present invention is not limited to these.

Now, chemical agents used in Examples and Comparative Examples will be collectively described below.
NR: TSR20
Brominated butyl rubber: Bromobutyl 2255 manufactured by Exxon Mobil Corporation
Reclaimed butyl rubber: Reclaimed butyl rubber manufactured by Car Quest (butyl rubber: 50 mass %, carbon black N660: 33 mass %, others (oil, ash content and the like): 17 mass %)
Non-halogenated butyl rubber: Butyl 268 manufactured by JAPAN BUTYL Co., Ltd.
Carbon black N762: Statex N762 (N₂SA: 29 m²/g) manufactured by Columbian Carbon
Carbon black N660: N660 (N₂SA: 35 m²/g) manufactured by Jiangxi Black Cat
Silica Z1085: Z1085Gr (N₂SA: 85 m²/g) manufactured by Rhodia
Silica VN3: ULTRASIL VN3 (N₂SA: 175 m²/ g) manufactured by Degussa
Non-reactive para-alkylphenol resin: SP1068 (non-reactive para-alkylphenol resin represented by formula (2) where R⁴: octyl group (—C₈H₁₇), m: 1 to 9) manufactured by NIPPON SHOKUBAI CO., LTD.
Resin mixture: 40MS (mixture of aromatic hydrocarbon resin and aliphatic hydrocarbon resin) manufactured by Struktol
Mineral oil: Diana process oil PA32 (paraffin oil) manufactured by Idemitsu Kosan Co., Ltd.
Zinc oxide: zinc oxide #2 manufactured by Mitsui Mining & Smelting Co., Ltd.
Stearic acid: Stearic acid “Tsubaki” manufactured by NOF Corporation
Bituminous coal: Austin Black 325 (average particle size: 5 μm, BET specific surface area: 9.0 m²/g) manufactured by Coal Fillers Inc.
Hard clay: Crown clay (average particle size: 0.6 μm) manufactured by Southeastern Clay Co.
5% oil-containing sulfur powder: HK-200-5 (oil content: 5 mass %) manufactured by Hosoi Chemical Industry Co., Ltd.
V200: TACKIROL V200 (alkylphenol-sulfur chloride condensate represented by formula (1) where R¹, R², R³: octyl group (—C₈H₁₇); x, y: 2; t: 0 to 100, sulfur content: 24 mass %, weight average molecular weight: 9000) manufactured by Taoka Chemical Co., Ltd.
TS3101: TS3101 (test product) (alkylphenol-sulfur chloride condensate represented by formula (1) where R¹, R², R³: dodecyl group (—C₁₂H₂₅) ; x, y: 2; t: 150 to 200, sulfur content: 27 mass %, weight average molecular weight: 62000) manufactured by Taoka Chemical Co., Ltd.
Vulcanization accelerator M: Nocceler M (2-mercaptobenzothiazole) manufactured by Ouchi Shinko Chemical Industrial Co., Ltd.
Retarder: Kyowamag LCM (magnesium oxide) manufactured by Kyowa Chemical Industry Co., Ltd.
Vulcanization accelerator DM: Nocceler DM (di-2-benzothiadyl disulfide) manufactured by Ouchi Shinko Chemical Industrial Co., Ltd.
C5 petroleum resin: Marukarez T-100AS (C5 petroleum resin: aliphatic petroleum resin formed mainly from olefins and diolefins in C5 fraction obtained by naphtha cracking) (softening point: 100° C.) manufactured by Maruzen Petrochemical Co., Ltd.

### Examples and Comparative Examples

The chemical agents except the zinc oxide, crosslinking agents (sulfur, alkylphenol-sulfur chloride condensates), vulcanization accelerators and retarder were mixed in accordance with each of the formulations shown in Tables 1 and 2 and kneaded in a 1.7 L Banbury mixer. Subsequently, to the obtained kneaded mixture, the zinc oxide, crosslinking agent(s), vulcanization accelerator(s) and retarder were added and kneaded with a roll to prepare an unvulcanized rubber composition. The obtained unvulcanized rubber composition was press-vulcanized at 150° C. for 30 minutes to prepare a vulcanized rubber composition.

Additionally, the obtained unvulcanized rubber composition was formed into the shape of an inner-liner joint strip, assembled with other tire components and then vulcanized at 150° C. for 30 minutes to prepare a test tire (all-steel tire for all seasons, tire size: 11R22.5 16PR). The vulcanization was performed with a BOM press-vulcanizer which was charged with saturated water vapor (temperature: 200° C., pressure: 15 ksc) for 5 minutes and then charged with nitrogen gas (temperature: room temperature, pressure: 28 ksc) for 25 minutes. It should be noted that the rubber compositions having the formulations shown in Table 3 were used for the inner liners of the test tires.

The unvulcanized rubber compositions, vulcanization rubber compositions and test tires obtained as above were evaluated as follows. The results are shown in Tables 1 and 2. Furthermore, the rubber compositions for an inner liner were evaluated in the same manner, and the results are shown in Table 3.

### (Scorch Time)

In accordance with the “Mooney scorch test” described in JIS K 6300-1: 2001, the time (scorch time (minutes): t10) until the Mooney viscosity of an unvulcanized rubber composition is increased by 10 M (M represents Mooney viscosity) was measured using an L-rotor at a measurement temperature of 130° C. Here, in measuring scorch time, an M versus time curve (unit: minute) showing the relationship between Mooney viscosity and time was prepared.

Since when a rubber sheet at room temperature is fed into an extruder and heated to increase fluidity, it needs to be extruded into a desired shape without compound scorch, and in order to prevent scorching of a rubber composition held for a long time in a rubber extruder in which the temperature of the rubber composition reaches approximately 130° C. upon discharging the rubber composition, the scorch time needs to be 11 minutes or more. If the scorch time is 11 minutes or more, it means that the rubber composition can be processed. Furthermore, the scorch time needs to be 20 minutes or less in order to avoid bareness due to undercure (uncompleted crosslinking) when the rubber composition is used to build a green tire and the green tire is vulcanized in a mold.

### (Viscoelasticity Test)

The complex elastic modulus (E*) and loss tangent (tan δ) of a vulcanized rubber composition were measured using a viscoelasticity spectrometer VES (manufactured by Iwamoto Seisakusho Co., Ltd.) at a temperature of 70° C., a frequency of 10 Hz, an initial strain of 10% and a dynamic strain of 2%. If the modulus E* falls within the desired range, it means that crack growth resistance is good. The smaller the value of tan δ, the better the fuel economy.

### (Tensile Test)

A tensile test was performed at room temperature using a No. 3 dumbbell-shaped test piece formed of a vulcanized rubber composition in accordance with JIS K 6251: 2010 “Rubber, vulcanized or thermoplastic—Determination of tensile stress-strain properties”, to measure elongation at break (EB (%)). Additionally, the same tensile test was applied to a sample prepared by allowing the test piece to stand still in an oven charged with air at 80° C. for 3 weeks, to measure elongation at break of the aged test piece (EB (%) after aging). The larger the value, the better the elongation at break.

### (Finished State of I/L Joint)

The joint of an inner liner (I/L) of a test tire (the number of samples: 10) was checked for appearance when built into a green tire and when vulcanized, and the results were expressed as an index relative to that of Comparative Example 1 (=100). It is preferred that the inner-liner joint strip be not peeled off, not rolled up to form a lump and not scorched; that the joint of the inner liner be not opened; that no depressed line be observed in the joint of the inner liner in appearance; and that the inner-liner joint strip be stretched flat to cover the joint of the inner liner. The larger the index value, the better the finished state of the I/L joint.

### (Air Permeability Test)

The air permeability of a vulcanized rubber composition was measured in accordance with the method of ASTM D-1434-75M, and the air permeability of each of the compositions was expressed as an index based on the following equation. The larger the air retention index, the lower the air permeability of the vulcanized rubber composition, and, in turn, the better the air retention properties.

(Air retention index)=(air permeability of Comparative Example 1)/(air permeability of each composition)×100

TABLE 1
Rubber compositions for inner-liner joint strip

| | | | Examples | | | | | | | | |
|---|---|---|---|---|---|---|---|---|---|---|---|
| | | | 1 | 2 | 3 | 4 | 5 | 6 | 7 | 8 | 9 |
| Formu- | NR | | 30 | 40 | 10 | 30 | 30 | 30 | 30 | 30 | 30 |
| lation | Brominated | | 70 | 60 | 90 | 70 | 70 | 70 | 70 | 70 | 70 |
| (part(s) | butyl rubber | | | | | | | | | | |
| by | Reclaimed | | — | — | — | — | — | — | — | — | — |
| mass) | butyl rubber | | | | | | | | | | |
| | (Butyl rubber | | | | | | | | | | |
| | content) | | | | | | | | | | |
| | Non-halogenated | | — | — | — | — | — | — | — | — | — |
| | butyl rubber | | | | | | | | | | |
| | Carbon black N762 | | — | — | — | — | — | — | — | 65 | — |
| | Carbon black N660 | | 50 | 50 | 50 | 40 | 25 | 25 | 25 | — | 50 |
| | Silica Z1085 | | — | — | — | — | — | 15 | — | — | — |
| | Silica VN3 | | — | — | — | — | — | — | 15 | — | — |
| | Non-reactive para- | | 3 | 3 | 3 | 3 | 3 | 3 | 3 | 3 | 3 |
| | alkylphenol resin | | | | | | | | | | |
| | Resin mixture | | — | — | — | — | — | — | — | — | — |
| | Mineral oil | | 7 | 7 | 7 | 7 | 4 | 4 | 4 | 12 | 7 |
| | Zinc oxide | | 3 | 3 | 3 | 3 | 3 | 3 | 3 | 3 | 3 |
| | Stearic acid | | 1 | 1 | 1 | 1 | 1 | 1 | 1 | 1 | 1 |
| | Bituminous coal | | — | — | — | — | 25 | 25 | 25 | — | — |
| | Hard clay | | — | — | — | — | — | — | — | — | — |
| | 5% oil-containing | | — | — | — | — | — | — | — | — | 0.1 |
| | sulfur powder | | | | | | | | | | |
| | V200 | | 1 | 1 | 1.5 | 1 | 1.5 | 1.5 | 1.5 | 1 | 0.5 |
| | TS3101 | | — | — | — | — | — | — | — | — | — |
| | Vulcanization | | — | — | — | — | — | — | — | — | — |
| | accelerator M | | | | | | | | | | |
| | Retarder | | — | — | — | — | — | — | — | — | — |
| | Vulcanization | | 1.25 | 1.25 | 1.25 | 1.25 | 1.25 | 1.25 | 1.25 | 1.25 | 1.5 |
| | accelerator DM | | | | | | | | | | |
| Rubber composition for inner liner | | | A | A | A | A | A | A | A | A | A |
| Eval- | Scorch | Target value: | 15.5 | 12.4 | 16.4 | 18.4 | 16.5 | 16.3 | 16.8 | 15.9 | 12.5 |
| uation | time | 11-20 | | | | | | | | | |
| | (minutes) | | | | | | | | | | |
| | E* | Target value: | 2.71 | 2.84 | 2.81 | 2.22 | 2.09 | 2.85 | 3.09 | 3.01 | 2.89 |
| | | 2.0-3.5 | | | | | | | | | |
| | Tanδ | Target value: | 0.192 | 0.175 | 0.215 | 0.176 | 0.161 | 0.173 | 0.189 | 0.202 | 0.211 |
| | | <0.25 | | | | | | | | | |
| | EB (%) | Target value: | 650 | 655 | 695 | 700 | 665 | 735 | 735 | 595 | 675 |
| | | >550 | | | | | | | | | |
| | EB (%) | Important | 570 | 520 | 605 | 625 | 515 | 645 | 655 | 525 | 585 |
| | after aging | target value: | | | | | | | | | |
| | | >490 | | | | | | | | | |
| | Index of | Important | 120 | 125 | 112 | 115 | 112 | 120 | 125 | 116 | 116 |
| | finished | target value: | | | | | | | | | |
| | state of | >110 | | | | | | | | | |
| | I/L joint | | | | | | | | | | |
| | Air | Target value: | 101 | 95 | 125 | 97 | 96 | 98 | 96 | 103 | 101 |
| | retention | >90 | | | | | | | | | |
| | index | | | | | | | | | | |

| | | | Examples | | | | | | | |
|---|---|---|---|---|---|---|---|---|---|---|
| | | | 10 | 11 | 12 | 13 | 14 | 15 | 16 | 17 |
| Formu- | NR | | 30 | 30 | 30 | 30 | 30 | 30 | 30 | 30 |
| lation | Brominated | | 70 | 70 | 70 | 55 | 60 | 70 | 70 | 70 |
| (part(s) | butyl rubber | | | | | | | | | |
| by | Reclaimed | | — | — | — | — | 20 (10) | — | — | — |
| mass) | butyl rubber | | | | | | | | | |
| | (Butyl rubber | | | | | | | | | |
| | content) | | | | | | | | | |
| | Non-halogenated | | — | — | — | 15 | — | — | — | — |
| | butyl rubber | | | | | | | | | |
| | Carbon black N762 | | — | — | — | — | — | — | — | — |
| | Carbon black N660 | | 50 | 50 | 50 | 50 | 43.5 | 50 | 50 | 25 |
| | Silica Z1085 | | — | — | — | — | — | — | — | — |
| | Silica VN3 | | — | — | — | — | — | — | — | — |
| | Non-reactive para- | | 3 | 3 | 3 | 3 | 3 | 3 | — | 3 |
| | alkylphenol resin | | | | | | | | | |
| | Resin mixture | | — | — | — | — | — | — | 3 | — |
| | Mineral oil | | 7 | 7 | 7 | 7 | 5 | 7 | 7 | 4 |
| | Zinc oxide | | 3 | 3 | 3 | 3 | 3 | 3 | 3 | 3 |
| | Stearic acid | | 1 | 1 | 1 | 1 | 1 | 1 | 1 | 1 |
| | Bituminous coal | | — | — | — | — | — | — | — | — |
| | Hard clay | | — | — | — | — | — | — | — | 25 |
| | 5% oil-containing | | 0.3 | — | — | — | — | — | — | — |
| | sulfur powder | | | | | | | | | |
| | V200 | | 0.25 | 3 | 4 | 1 | 1 | — | 1 | 1 |
| | TS3101 | | — | — | — | — | — | 1 | — | — |
| | Vulcanization | | — | — | — | — | — | — | — | — |
| | accelerator M | | | | | | | | | |
| | Retarder | | — | — | — | — | — | — | — | — |
| | Vulcanization | | 1.75 | 0.75 | 0.4 | 1.25 | 1.25 | 1.25 | 1.25 | 1.25 |
| | accelerator DM | | | | | | | | | |
| Rubber composition for inner liner | | | A | A | A | A | A | A | A | A |
| Eval- | Scorch | Target value: | 11.6 | 14.1 | 13.5 | 17.5 | 17.8 | 18.1 | 14.5 | 16.6 |
| uation | time | 11-20 | | | | | | | | |
| | (minutes) | | | | | | | | | |
| | E* | Target value: | 2.65 | 2.95 | 3.45 | 2.55 | 2.34 | 2.74 | 2.73 | 2.75 |
| | | 2.0-3.5 | | | | | | | | |
| | Tanδ | Target value: | 0.226 | 0.175 | 0.164 | 0.201 | 0.216 | 0.191 | 0.187 | 0.188 |
| | | <0.25 | | | | | | | | |
| | EB (%) | Target value: | 680 | 635 | 595 | 640 | 655 | 660 | 685 | 655 |
| | | >550 | | | | | | | | |
| | EB (%) | Important | 590 | 525 | 500 | 555 | 545 | 580 | 595 | 515 |
| | after aging | target value: | | | | | | | | |
| | | >490 | | | | | | | | |
| | Index of | Important | 111 | 122 | 112 | 115 | 113 | 120 | 115 | 125 |
| | finished | target value: | | | | | | | | |
| | state of | >110 | | | | | | | | |
| | I/L joint | | | | | | | | | |
| | Air | Target value: | 101 | 100 | 100 | 101 | 100 | 101 | 104 | 96 |
| | retention | >90 | | | | | | | | |
| | index | | | | | | | | | |

TABLE 2
Rubber compositions for inner-liner joint strip

| | | | Comparative Examples | | | | | | | | | | | |
|---|---|---|---|---|---|---|---|---|---|---|---|---|---|---|
| | | | 1 | 2 | 3 | 4 | 5 | 6 | 7 | 8 | 9 | 10 | 11 | 12 |
| Formu- | NR | | 30 | 15 | 50 | 50 | 30 | 30 | 30 | 30 | 30 | 30 | 30 | 30 |
| lation | Brominated | | 70 | 85 | 50 | 50 | 70 | 70 | 70 | 70 | 70 | 70 | 70 | 70 |
| (part(s) | butyl rubber | | | | | | | | | | | | | |
| by | Reclaimed | | — | — | — | — | — | — | — | — | — | — | — | — |
| mass) | butyl rubber | | | | | | | | | | | | | |
| | (Butyl rubber | | | | | | | | | | | | | |
| | content) | | | | | | | | | | | | | |
| | Non-halogenated | | — | — | — | — | — | — | — | — | — | — | — | — |
| | butyl rubber | | | | | | | | | | | | | |
| | Carbon black N762 | | — | — | — | — | — | — | — | 65 | — | — | — | — |
| | Carbon black N660 | | 50 | 50 | 50 | 50 | 50 | 50 | 20 | — | 50 | 50 | 50 | 50 |
| | Silica Z1085 | | — | — | — | — | — | — | — | 7 | — | — | — | — |
| | Silica VN3 | | — | — | — | — | — | — | — | — | — | — | — | — |
| | Non-reactive para- | | 3 | 3 | 3 | 3 | 3 | 3 | 3 | 3 | 3 | 3 | 3 | 3 |
| | alkylphenol resin | | | | | | | | | | | | | |
| | Resin mixture | | — | — | — | — | — | — | — | — | — | — | — | — |
| | Mineral oil | | 7 | 7 | 7 | 7 | 7 | 7 | 4 | 12 | 7 | 7 | 7 | 7 |
| | Zinc oxide | | 3 | 3 | 3 | 3 | 3 | 3 | 3 | 3 | 3 | 3 | 3 | 3 |
| | Stearic acid | | 1 | 1 | 1 | 1 | 1 | 1 | 1 | 1 | 1 | 1 | 1 | 1 |
| | Bituminous coal | | — | — | — | — | — | — | 30 | — | — | — | — | — |
| | Hard clay | | — | — | — | — | — | — | — | — | — | — | — | — |
| | 5% oil-containing | | 0.5 | 0.5 | — | 0.5 | 0.45 | — | — | — | 0.5 | 0.5 | 0.5 | 0.5 |
| | sulfur powder | | | | | | | | | | | | | |
| | V200 | | — | — | 1 | — | 0.08 | 6 | 2 | 1 | — | — | — | — |
| | TS3101 | | — | — | — | — | — | — | — | — | — | — | — | — |
| | Vulcanization | | — | — | — | — | — | — | — | — | 0.85 | — | — | — |
| | accelerator M | | | | | | | | | | | | | |
| | Retarder | | — | — | — | — | — | — | — | — | — | 1.00 | — | — |
| | Vulcanization | | 1.25 | 1.25 | 1.25 | 1.25 | 1.25 | 0.3 | 1.25 | 1.25 | 0.4 | 1.25 | 1.25 | 1.25 |
| | accelerator DM | | | | | | | | | | | | | |
| Rubber composition for inner liner | | | A | A | A | A | A | A | A | A | A | A | B | C |
| Eval- | Scorch | Target value: | 16.1 | 18.6 | 9.2 | 12.3 | 16.1 | 8.2 | 13.1 | 18.7 | 7.1 | 30.5 | 16.1 | 16.1 |
| uation | time | 11-20 | | | | | | | | | | | | |
| | (minutes) | | | | | | | | | | | | | |
| | E* | Target value: | 3.02 | 2.85 | 3.11 | 3.45 | 3.02 | 3.85 | 2.35 | 3.05 | 2.95 | 2.95 | 3.02 | 3.02 |
| | | 2.0-3.5 | | | | | | | | | | | | |
| | Tanδ | Target value: | 0.217 | 0.238 | 0.171 | 0.194 | 0.213 | 0.162 | 0.155 | 0.217 | 0.223 | 0.217 | 0.217 | 0.217 |
| | | <0.25 | | | | | | | | | | | | |
| | EB (%) | Target value: | 675 | 705 | 615 | 585 | 675 | 540 | 615 | 545 | 655 | 615 | 675 | 675 |
| | | >550 | | | | | | | | | | | | |
| | EB (%) | Important | 525 | 605 | 485 | 455 | 530 | 405 | 465 | 425 | 495 | 485 | 525 | 525 |
| | after aging | target value: | | | | | | | | | | | | |
| | | >490 | | | | | | | | | | | | |
| | Index of | Important | 100 | 85 | 125 | 125 | 103 | 95 | 95 | 105 | 70 | 65 | 115 | 75 |
| | finished | target value: | | | | | | | | | | | | |
| | state of | >110 | | | | | | | | | | | | |
| | I/L ioint | | | | | | | | | | | | | |
| | Air | Target value: | 100 | 112 | 75 | 75 | 100 | 100 | 91 | 101 | 100 | 96 | 100 | 100 |
| | retention | >90 | | | | | | | | | | | | |
| | index | | | | | | | | | | | | | |

TABLE 3
Rubber compositions for inner liner

| | | Rubber compositions | | |
|---|---|---|---|---|
| | | A | B | C |
| Formulation | Brominated butyl rubber | 100 | 100 | 100 |
| (part(s) | Carbon black N660 | 60 | 45 | 60 |
| by mass) | Silica Z1085 | — | 15 | — |
| | Zinc oxide | 3 | 3 | 3 |
| | Stearic acid | 1 | 1 | 1 |
| | 5% oil-containing | 0.6 | 0.3 | 0.6 |
| | sulfur powder | | | |
| | V200 | — | 0.5 | — |
| | Retarder | — | — | 1 |
| | Vulcanization accelerator DM | 1.25 | 1.25 | 1.25 |
| | C5 petroleum resin | 5 | 5 | 5 |
| | Non-reactive | 5 | 5 | 5 |
| | para-alkylphenol resin | | | |
| | Mineral oil | 10 | 10 | 10 |
| Evaluation | Scorch time (minutes) | 14.5 | 15.1 | 33.5 |
| | E* | 3.77 | 3.84 | 3.79 |
| | Tanδ | 0.251 | 0.225 | 0.249 |
| | EB (%) | 750 | 735 | 710 |
| | EB (%) after aging | 660 | 645 | 620 |
| | Air retention index | 180 | 180 | 172 |

In each of Examples using: a butyl rubber; silica and/or carbon black; and an alkylphenol-sulfur chloride condensate represented by formula (1), each in a predetermined amount, the finished state of the joint of the inner liner was greatly improved compared to Comparative Example 1. In addition, fuel economy, crack growth resistance, elongation at break and air retention properties were in acceptable levels in practice.

In Comparative Examples 10 and 12 in which the scorch time of the rubber composition for an inner-liner joint strip greatly differs from the scorch time of the rubber composition for an inner liner, these tire components were unable to be synchronously cured, and the finished state of the joint of the inner liner was greatly inferior to Comparative Example 1.

In Comparative Example 11 in which a rubber composition for an inner liner containing V200 was used, co-curing between the inner-liner joint strip and the inner liner was accelerated and therefore relatively good properties were obtained; however, the finished state of the joint of the inner liner was inferior to Example 1 using an inner-liner joint strip containing V200.

### REFERENCE SIGNS LIST

1 Inner-liner joint strip
2 Inner liner
3 Tie gum
4 Filler
5 Carcass ply
6 Rubber chafer
7 Tread
8 Steel breakers

1. A rubber composition for an inner-liner joint strip, comprising a butyl rubber, at least one of silica and carbon black, and an alkylphenol-sulfur chloride condensate represented by the following formula (1): 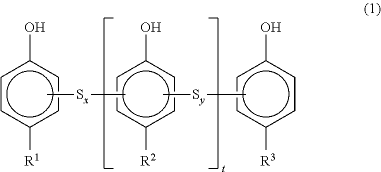
wherein R¹, R² and R³, which may be the same or different, each represent an alkyl group having 5 to 12 carbon atoms; x and y, which may be the same or different, each represent an integer of 1 to 3; and t represents an integer of 0 to 250,
wherein a butyl rubber content is 60 to 100 mass % based on 100 mass % of a rubber component of the rubber composition,
a total combined amount of the silica and the carbon black is 21 to 70 parts by mass per 100 parts by mass of the rubber component, and
an amount of the alkylphenol-sulfur chloride condensate is 0.1 to 5 parts by mass per 100 parts by mass of the rubber component.

2. The rubber composition for an inner-liner joint strip according to claim 1, wherein a sulfur content is 0 to 0.4 parts by mass per 100 parts by mass of the rubber component.

3. A pneumatic tire, comprising an inner-liner joint strip formed from the rubber composition according to claim 1, and an inner liner,
wherein an initial curing rate t10 of the inner-liner joint strip and an initial curing rate t10 of the inner liner satisfy the following relationship:
0.5≦(initial curing rate t10 of inner-liner joint strip)/(initial curing rate t10 of inner liner)≦2.

4. The pneumatic tire according to claim 3, which is a tire with steel belts and a steel carcass.
